(19) United States
(12) Patent Application Publication
(10) Pub. No.: US 2016/0083977 A1
(43) Pub. Date: Mar. 24, 2016

(54) PADLOCK RETAINING DEVICE

(71) Applicant: Mark A. Pickard, Riverside, CA (US)

(72) Inventor: Mark A. Pickard, Riverside, CA (US)

(21) Appl. No.: 14/683,317

(22) Filed: Apr. 10, 2015

Related U.S. Application Data
(60) Provisional application No. 62/052,134, filed on Sep. 18, 2014.

(51) Int. Cl. E05B 17/00

(52) U.S. Cl. CPC E05B 17/00

(57) ABSTRACT

A padlock retaining device has: a) a stand-alone body, separate from any locking device or latching device, the body having one or more body attachment facilitators and b) a lock containment section attached to and extending away from the body for accepting and retaining an open padlock.

### RELATED APPLICATIONS

This application claims priority from U.S. Patent Application Ser. No. 62/052,134 entitled “Padlock Retaining Device,” filed Sep. 18, 2014, the entirety of which is incorporated herein by reference.

### BACKGROUND

Roll-up doors are used for a wide variety of applications. For example, roll-up doors are frequently used to secure the interiors of enclosed storage areas, such as the areas within storage units in a commercial self-storage rental facility.

When used to secure the interior of enclosed storage areas, the roll-up doors are typically made from steel and the doors are provided with a locking apparatus. In the most common applications, such locking apparatuses comprise at least one slidable bolt attached to the door or a strong slide rail. FIG. 1 illustrates such a locking apparatus. The slidable bolt can be alternatively (1) slid in one direction along the slide rail to a “latched position,” wherein the bolt is caused to protrude into a strike plate mounted on the door frame (to prevent the door from traveling upward) and (2) slid in the opposite direction along the slide rail to an “unlatched position,” wherein the bolt is retracted out of the strike plate (to allow the door to again freely travel upward).

Typically, the slide rail and the slidable bolt each have a padlock retainer portion defining a locking through-hole which is sized and dimensioned to accept a padlock shackle (curved portion). The holes in the padlock retainer portions are located so that, when the bolt is slid to the latched position, the holes are aligned with one another such that a padlock shackle can be placed and secured within both holes to lock the bolt within the latched position (as illustrated in FIG. 2).

It is also common that both the slide rail and the bolt have an auxiliary hole—termed a manager's overlock hole—which can be used by the manager of a facility employing the roll-up door to lock the door in the latched position (for example, if rent is overdue). The manager's overlock hole can also be used to retain the padlock on the roll-up door when the bolt is in the unlatched position. This design seems to provide the user with a convenient place to store the padlock when it is not being used, such as immediately after the user unlocks the padlock and slides the bolt to the unlatched position in preparation for opening the roll-up door. The problem with this design, however, is that, if the user forgets to remove the padlock from the manager's overlock hole before the roll-up door is opened, the padlock will be carried upwards as the roll-up door is opened and strike the upper horizontal portion of the door frame. This illustrated in FIG. 3. Because roll-up doors are typically heavy and carry considerable momentum, such striking of the door frame can cause significant damage to the door frame, to the latch assembly and/or to the roll-up door. If the door frame is made of steel or other heavy material, the striking of the door frame with the padlock can rip the latch assembly off of the roll-up door.

Accordingly, there is a need for a padlock retaining device that addresses the problem often encountered with the use of roll-up doors.

### SUMMARY OF THE INVENTION

The invention satisfies this need. The invention is a unique padlock retaining device. The padlock retaining device comprises: a) a stand-alone body, separate from any locking device or latching device, the body having one or more body attachment facilitators and b) a lock containment section attached to and extending away from the body for accepting and retaining an open padlock.

The invention is also a method of employing the padlock retaining device to prevent damage caused by inadvertently opening a roll-up door with a padlock still attached to the roll-up door.

### DRAWINGS

These and other features, aspects and advantages of the present invention will become better understood with reference to the following description, appended claims, and accompanying drawings where:

FIG. 1 is a sketch illustrating a slide lock of the prior art;

FIG. 2 is a sketch illustrating a slide lock attached to a roll up door disposed within a door frame, wherein a padlock has been operably placed on the slide lock to secure the slide lock in a latched position;

FIG. 3 is a sketch illustrating the roll up door of FIG. 2 wherein the padlock has been opened and hung loosely on the slide lock and wherein the roll up door has been rolled up to inadvertently cause the padlock to strike the top of the door frame;

FIG. 4 is a perspective view of a padlock retaining device having features of the invention;

FIG. 5 is a front view of the padlock retaining device illustrated in FIG. 4;

FIG. 6 is a side view of the padlock retaining device illustrated in FIG. 4;

FIG. 7 is a top view of the padlock retaining device illustrated in FIG. 4; and

FIG. 8 is a sketch illustrating a slide lock attached to a roll up door disposed within a door frame, and a padlock opened and hung loosely on a padlock retaining device having features of the invention.

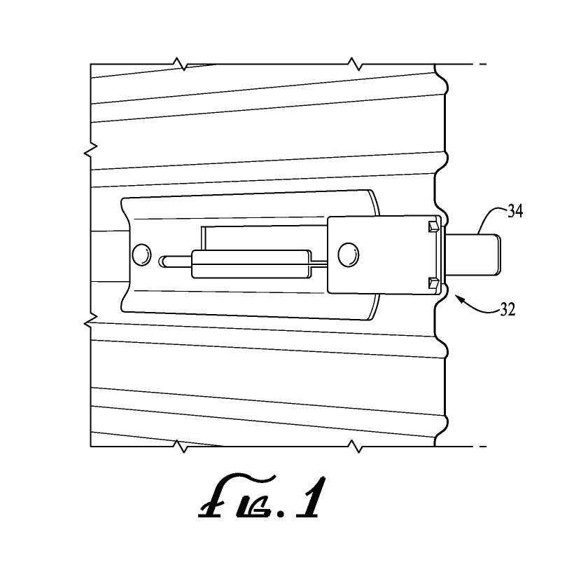

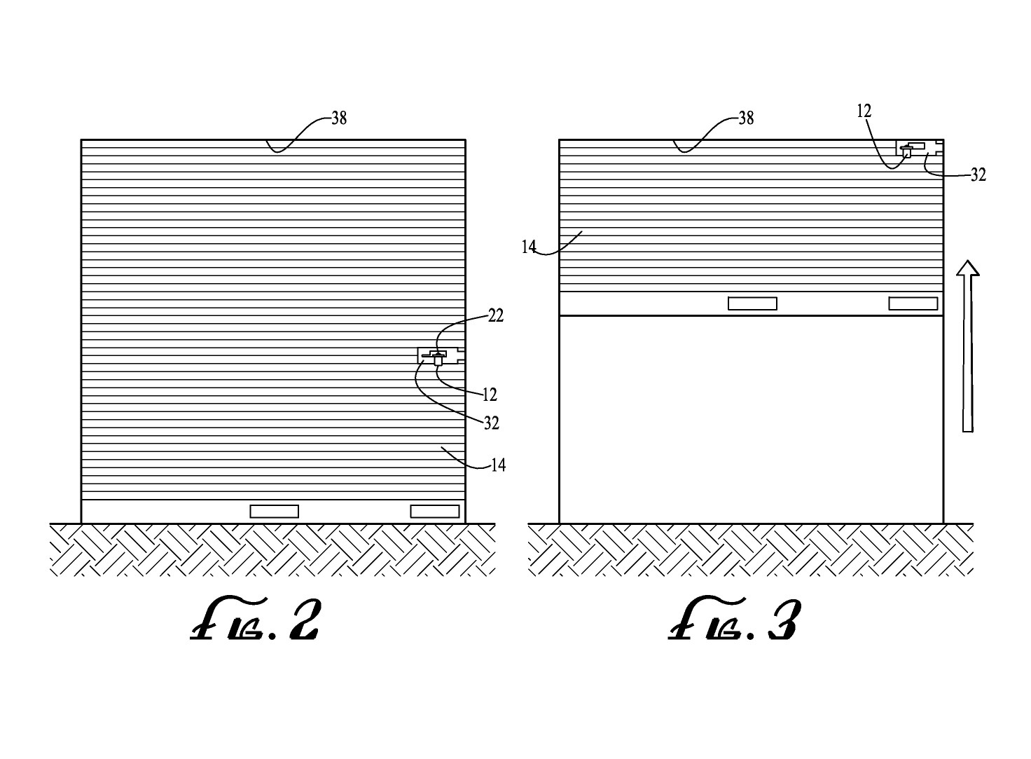

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

### DEFINITIONS

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

### The Invention

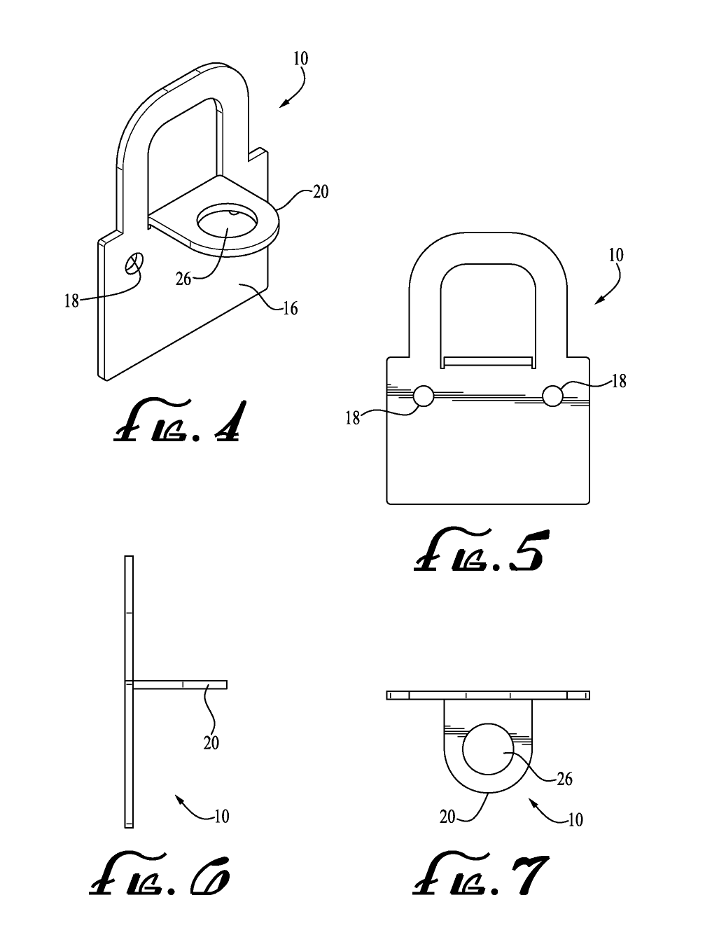

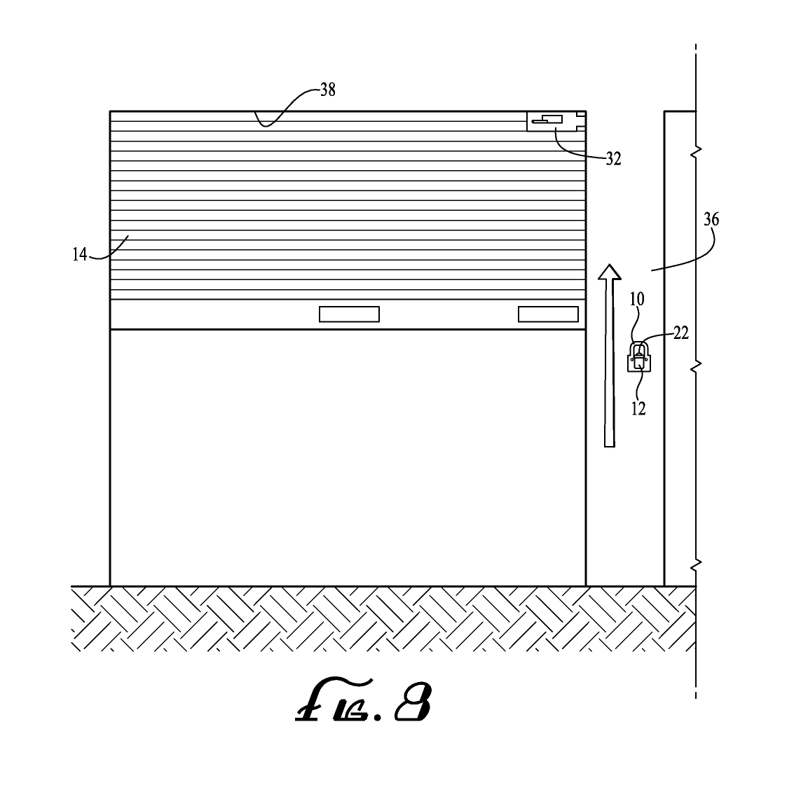

In one aspect, the invention is a padlock retaining device 10 built specifically to hold a padlock 12 in a convenient location adjacent to a roll-up door 14, not on the roll-up door 14 itself. FIGS. 4-7 illustrate one embodiment of the invention.

The padlock retaining device 10 comprises a body 16, one or more body attachment facilitators 18, and a lock containment section 20. The padlock retaining device 10 can be any size and dimension, and made from any material, including plastic, wood or metal. In the embodiment illustrated in FIGS. 4-7, the padlock retaining device 10 can be 2 and ¾ inches tall, 1 and ⅞ inches wide and preferably can be made from a single plate of steel.

The body 16 can be any shape and dimension, but preferably the body 16 is planar. In the embodiment illustrated in FIGS. 4-7, the padlock retaining device 10 has two body attachment facilitators 18 which be used to attach the padlock retaining device 10 to a wall surface 36 adjacent a roll-up door 14. Optionally, the two body attachment facilitators 18 can be fastener holes, and the padlock retaining device 10 can be attached to the wall surface 36 using any type of fastener, for example, stainless steel fasteners, screws or rivets depending on the application.

The lock containment section 20 is configured to accept and retain a padlock shackle 22. The lock containment section 20 is coupled to the body 16 at a sufficient angle to accept and retain a padlock shackle 22. The lock containment section 20 can be made from any material, including plastic, wood or metal, but preferably it is made from steel. The lock containment section 20 can be any size and dimension, but preferably it is about ⅞ inches long.

Optionally, the padlock retaining device 10 can be made from a single plate of steel, as shown in the embodiment illustrated in FIGS. 4-7. Because the padlock retaining device 10 can be made from a single plate of steel, the lock containment section 20 is a portion of the padlock retaining device 10 that is bent away from the body 16. Preferably the lock containment section 20 is bent away from the body 16 at a 90 degree angle with respect to the body 16.

The lock containment section 20 can also have a padlock shackle retaining hole 26 defined therein. The padlock shackle retaining hole 26 is sized and dimensioned to accept and retain a padlock shackle 22. The padlock shackle 22 is inserted through the padlock shackle retaining hole 26 such that the padlock 12 is now retained by the padlock retaining device 10.

In another aspect, the invention is a method of employing the padlock retaining device 10 to prevent damage caused by inadvertently opening a roll-up door 14 with a padlock 12 still attached to the roll-up door 14.

The padlock retaining device 10 is especially useful for a roll-up door 14 comprising a locking apparatus 32 having:
a slidable bolt 34 attached to the door on a slide rail, wherein the bolt 34 can be alternatively (1) slid in one direction along the slide rail to a “latched position,” wherein the bolt 34 is caused to protrude into a strike plate mounted on the door frame (to prevent the roll-up door 14 from travelling upward) and (2) slid in the opposite direction along the slide rail to an “unlatched position,” wherein the bolt 34 is retracted out of the strike plate (to allow the roll-up door 14 to again freely travel upward);
padlock retainer portions defined within both the slide rail and the bolt 34 to provide a locking through-hole which is sized and dimensioned to accept a padlock shackle 22, the holes in the padlock retainer portions being located so that, when the bolt 34 is slid to the latched position, the holes are aligned with one another such that a padlock shackle 22 can be placed and secured within both holes to lock the bolt 34 within the latched position; and
a manager's overlock hole defined in both the slide rail and the bolt 34 which is operatively configured to retain the padlock 12 on the roll-up door when the bolt 34 is in the unlatched position.

As discussed above, many users secure the padlock 12 to the manager's overlock hole (not shown) after they have removed the padlock 12 from the roll-up door 14, but prior to actually opening the roll-up door 14. Then the roll-up door 14 is moved upward to an open position, which causes the locking apparatus 32 to strike the upper portion of the door frame 38.

In the method, the padlock retaining device 10 is attached to a wall surface 36—typically a vertical wall surface—separate from the roll-up door 14 for which a padlock 12 is used to secure the roll-up door 14 in the latched position. Then the padlock 12 is retained on the padlock retaining device 10 when the padlock 12 is not in use by disposing the padlock shackle 22 into the padlock shackle retaining hole 26—as illustrated in FIG. 8.

The method of employing the padlock retaining device 10 comprises the steps of providing the padlock retaining device 10, attaching the padlock retaining device 10 to a wall surface 36 separate from the roll-up door 14 by the one or more body attachment facilitators 18, disposing the padlock shackle 22 into the lock containment section 20, and retaining the padlock 12 on the padlock retaining device 10 when the padlock 12 is not in use.

The method effectively prevents damage to the roll-up door 14, the locking apparatus 32 and/or the door frame 38 by inadvertently rolling the roll-up door 14 upwards while the padlock 12 is attached in the auxiliary manager's overlock hole of the locking apparatus 32—thereby causing the locking apparatus 32 to strike the upper portion of the door frame 38.

What is claimed is:

1. A padlock retaining device comprising:
a. a stand-alone body, separate from any locking device or latching device, the body having one or more body attachment facilitators; and
b. a lock containment section attached to and extending away from the body for accepting and retaining an open padlock.

2. The padlock retaining device according to claim 1, wherein the body is planar.

3. The padlock retaining device according to claim 1, wherein the one or more body attachment facilitators comprise fastener holes.

4. The padlock retaining device according to claim 1, wherein the lock containment section extends away from the body at a 90 degree angle with respect to the body.

5. The padlock retaining device according to claim 1, wherein the lock containment section further comprises a padlock shackle retaining hole.

6. The padlock retaining device according to claim 1, wherein the padlock retaining device is made from a single plate of steel.

7. The padlock retaining device according to claim 1, wherein the body of the padlock retaining device is 2 and ¾ inches tall.

8. The padlock retaining device according to claim 1, wherein the body of the padlock retaining device is 1 and ⅞ inches wide.

9. A padlock retaining device comprising:
a. a stand-alone planar body, separate from any locking device or latching device, wherein the planar body has one or more body attachment facilitators comprising fastener holes; and
b. a lock containment section attached to and extending away from the planar body at a 90 degree angle with respect to the planar body, the lock containment section configured for accepting and retaining an open padlock, wherein the lock containment section further comprises a padlock shackle retaining hole.

10. The padlock retaining device according to claim 9, wherein the padlock retaining device is made from a single plate of steel.

11. The padlock retaining device according to claim 9, wherein the planar body of the padlock retaining device is 2 and ⅜ inches tall.

12. The padlock retaining device according to claim 9, wherein the planar body of the padlock retaining device is 1 and ⅞ inches wide.

13. A method of employing a padlock retaining device for use with a roll up door, the roll up door comprising a locking apparatus, the locking apparatus comprising: i) a slidable bolt coupled to the roll up door on a slide rail, ii) holes in padlock retainer portions defined within both the slide rail and the slidable bolt to provide a locking through-hole which is sized and dimensioned to accept a padlock shackle, and iii) a manager's overlock hole defined in both the slide rail and the slidable bolt which is operatively configured to retain a padlock on the roll up door when the slidable bolt is in a unlatched position, the method comprising the steps of:
a. providing the padlock retaining device according to claim 1;
b. attaching the padlock retaining device to a wall surface separate from the roll up door by the one or more body attachment facilitators;
c. disposing the padlock shackle into the lock containment section; and
d. retaining the padlock on the padlock retaining device when the padlock is not in use.

14. The method of claim 13, wherein the body of the padlock retaining device is planar.

15. The method of claim 13, wherein the one or more body attachment facilitators comprise fastener holes.

16. The method of claim 13, wherein the lock containment section extends away from the body at a 90 degree angle with respect to the body.

17. The method of claim 13, wherein the lock containment section further comprises a padlock shackle retaining hole.

18. The method of claim 13, wherein the padlock retaining device is made from a single plate of steel.

19. The method of claim 13, wherein the body of the padlock retaining device is 2 and ¾ inches tall.

20. The method of claim 13, wherein the body of the padlock retaining device is 1 and ⅞ inches wide.
